(19) United States
(12) Patent Application Publication
(10) Pub. No.: US 2009/0253548 A1
(43) Pub. Date: Oct. 8, 2009

(54) TORQUE VECTORING AXLE ASSEMBLY

(76) Inventor: Dan J. Showalter, Plymouth, MI (US)

Correspondence Address: BorgWarner/BHGL, 524 South Main Street, Suite 200, Ann Arbor, MI, 48104, US

(21) Appl. No.: 12/416,577

(22) Filed: Apr. 1, 2009

Related U.S. Application Data
(60) Provisional application No. 61/041,949, filed on Apr. 3, 2008.

(51) Int. Cl. F16H 48/06

(52) U.S. Cl. 475/225

(57) ABSTRACT

In at least one embodiment of the present invention, a torque vectoring axle assembly for a non-driven axle of a motor vehicle is provided. The assembly comprises a first torque vectoring system (12) and a non-driven differential (16) that includes a differential carrier (24). The first torque vectoring system (12) includes a first shaft (30) configured to receive a first torque output from the non-driven differential (16) and to rotate about a shaft central axis (42). In communication with the first shaft (30) is a first gear (44) that is configured to rotate in conjunction with the first shaft (30) about the shaft central axis (42). In communication with the differential carrier (24) is a second gear (46) that is configured to rotate about the shaft central axis (42). A first set of planet gears (50) are in communication with the first and second gears (44, 46). The first and second gears (44, 46) have a first gear ratio other than one.

### CROSS REFERENCE TO RELATED APPLICATIONS

This application claims priority to and all available benefits of U.S. Provisional Patent Application 61/041,949, filed Apr. 3, 2008, the entire contents of which are herein incorporated by reference.

### FIELD OF THE INVENTION

This invention relates to an axle assembly for a motor vehicle which includes a differential design that provides axle torque vectoring capabilities.

### BACKGROUND OF THE INVENTION

Differentials allow differences in wheel rotational speed of a motor vehicle to occur between the left and right side half-shafts (and between front and rear axles in some applications). The earliest and most basic designs of differentials are known as open differentials in that they provide equal torque between the two half-shafts and do not operate to control the relative rotational speeds of the axle shafts. A well known disadvantage of open differentials occurs when one of the driven wheels engages the road surface with a low coefficient of friction (μ) with the other having a higher μ. In such case, the low tractive force developed at the low μ contact surface prevents significant torque from being developed on either axle. Since the torque between the two axle shafts is relatively equal, little total tractive force can be developed to pull the vehicle from its position. Similar disadvantages occur in dynamic conditions when operating, especially in low μ or so-called split μ driving conditions.

The above limitations of open differentials are well known and numerous design approaches have been employed to address such shortcomings. One approach is known as a limited slip or locking differential. These systems are typically mechanically or hydraulically operated or use other strategies to attempt to couple the two axle shafts together to rotate at nearly equal speeds. Thus, in this operating condition, the two axles are not mutually torque limited. A mechanically based locking or limited slip differential typically uses a clutch pack or friction material interface which locks the two axles together when a significant speed difference between the axles occurs. Other systems incorporate fluid couplings between the axles which provide a degree of speed coupling.

Although the above described locking and limited slip differential systems provide significant benefits over open differentials in many operating conditions, they too have significant limitations. For example, reliability and warranty problems are issues with many locking differential designs. Locking differentials using a mechanical friction interface are subject to wear of the friction materials.

Vehicle powertrain and suspension system designers consider forces acting at the tire contact patches to achieve desirable traction, braking, handing and steering behavior for the vehicle. The resultant forces acting at the tire patches can be resolved into longitudinal and lateral vector components. Automotive designers often desire to manage these tire force vectors to provide desirable handling characteristics. In particular, front-wheel drive vehicles typically exhibit under-steer characteristics. Application of the throttle generates driving forces on the front tires which will lead to tire slippage to the road surface when the lateral vector components can no longer be supported. Under these conditions, the vehicle will loose steering response in a turn. Current technologies will use braking torque to provide wheel contact vectoring to prevent under-steer conditions, as well as over-steer conditions, in maneuvering around curves. Such electronic controlled braking systems are known by various names and acronyms including dynamic stability control (DSC), and electronic stability program (ESP). These systems, however, only operate in an energy dampening (i.e. braking) mode. It would be highly desirable to provide wheel contact vectoring through a managed re-distribution of torque at various wheels, preferably without the cost and complexity of transmission modifications or propshaft and hypoid gearing at the rear axle for a front wheel drive vehicle.

### BRIEF SUMMARY OF THE INVENTION

In at least one embodiment of the present invention, a torque vectoring axle assembly for a non-driven axle of a motor vehicle is provided. The assembly comprises a non-driven differential (i.e. not connected to the vehicle engine) and a first torque vectoring system. The non-driven differential includes a differential carrier. The first torque vectoring system includes a first shaft configured to receive a first torque output from the non-driven differential and to rotate about a shaft central axis. In communication with the first shaft is a first gear that is configured to rotate in conjunction with the first shaft about the shaft central axis. In communication with the differential carrier is a second gear that is configured to rotate about the shaft central axis. A first set of planet gears mesh with the first and second gears. The first and second gears have a first gear ratio, relative to each other, that is other than one.

In other aspects of the present invention, the first gear has a different number of teeth than the second gear. At least one planet gear of the first set of planet gears engage both the first and second gears. The assembly further comprises a first carrier configured to house the first set of planet gears about a circumference of the first carrier. The first carrier is configured to rotate about the shaft central axis. A first coil electrical assembly includes a first coil for generating a first electromagnetic force. Located adjacent to the first coil assembly is a first armature. The first electromagnetic force pulls the first armature assembly towards the first coil assembly when activated. The first armature assembly is configured to move axially along the shaft central axis. In communication with the first carrier is a first clutch pack. A first retaining plate is attached to the first armature assembly and is configured to compress the first clutch pack.

In yet another aspect of the present invention, a second torque vectoring system may be mirrored of the first toque vectoring system.

These and other aspects and advantages of the present invention will become apparent upon reading the following detailed description of the invention in combination with the accompanying drawings.

### BRIEF DESCRIPTION OF THE DRAWINGS

FIG. 1 is a sectional top view of a torque vectoring axle assembly in accordance with at least one embodiment of the present invention;

FIG. 2 is a partial sectional top view of the torque vectoring axle assembly;

FIG. 3 is a perspective view of a housing and coil assembly;

FIG. 4 is an assembly view of the armature;

FIG. 5 is a perspective view of the armature and the reaction plate;

FIG. 6 is a perspective view of the armature attached to the reaction plate;

FIG. 7 is a partial perspective view of the torque vectoring axle assembly illustrating the alignment of the armature with the grounding ring;

FIG. 8 is a partial perspective view of the torque vectoring axle assembly illustrating the assembly of the clutch pack;

FIG. 9 is a partial perspective view of the torque vectoring axle assembly illustrating attachment of the retaining plate;

FIG. 10 is a perspective view of a carrier including planet gears and scoops;

FIG. 11 is a partial perspective view of the torque vectoring axle assembly illustrating the alignment of the carrier to the clutch pack;

FIG. 12 is a partial perspective view of the torque vectoring axle assembly illustrating insertion of the intermediate shaft;

FIG. 13 is a partial perspective view of the torque vectoring axle assembly illustrating insertion of the first sun gear; and

FIG. 14 is a partial perspective view of the torque vectoring axle assembly illustrating insertion of the second sun gear.

### DETAILED DESCRIPTION OF THE INVENTION

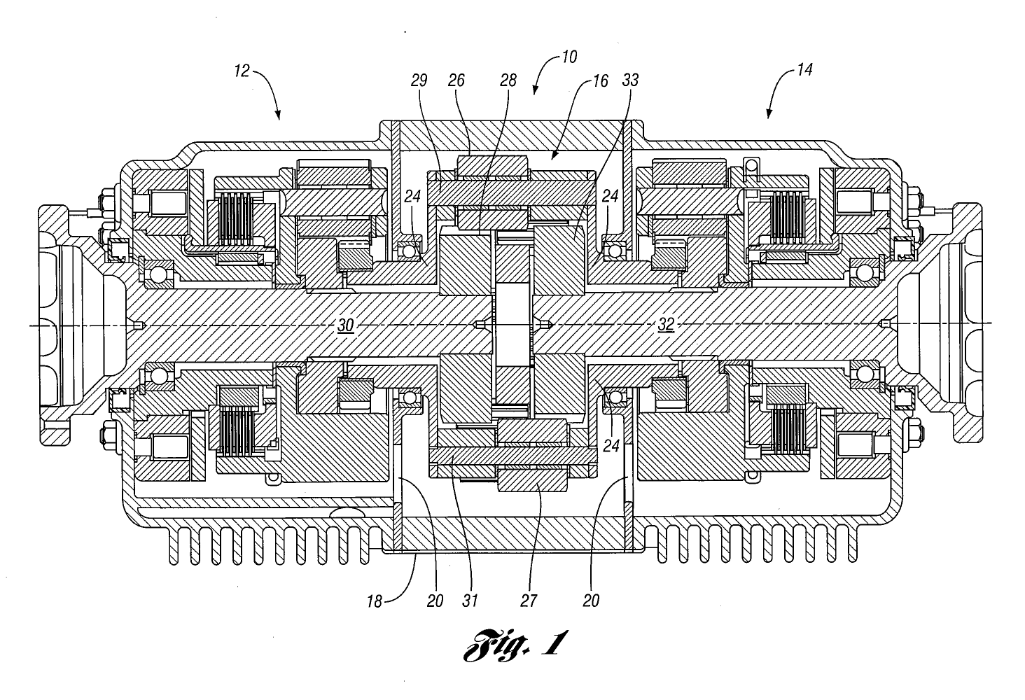

A torque vectoring axle assembly is shown in FIG. 1 and is generally designated by reference number 10. The basic components of the assembly 10 includes a left torque vectoring system 12, a right torque vectoring system 14, and non-driven differential 16. The non-driven differential 16 does not receive any input torque from an engine and the assembly 10 is preferably for a non-steering axle system, such as for example, a rear axle system for a front wheel drive vehicle. Accordingly, the non-driven differential 16 may be configured without a ring gear, which is typically large and is for receiving input torque from the engine. In one example, this configuration provides a more compact assembly package than a driven differential system and may be more easily integrated into a vehicle without costly and complex modifications to the transmission and related vehicle structure. The non-driven differential 16 may be an open differential, such as for example, a planetary gear set differential and/or an all spur gear differential.

The non-driven differential 16 includes a differential housing 18, a differential carrier 24 and at least two pinion gears, a pinion left gear 26 and a pinion right gear 27. The differential housing 18 may be formed from aluminum to reduce weight. Although, it is understood that the housing 18 may be formed from steel or other rigid materials. The pinion left and right gears 26 and 27 are rotatable, respectively, about a pinion left pin 29 and a pinion right pin 31 which are mounted to the differential carrier 24. The pinion left gear 26 meshes with the pinion right gear 27. The pinion gears 26 and 27 mesh, respectively, with a side gear left 28 and a side right gear 33 which are in turn splined or otherwise connected, respectively, with a left shaft 30 and a right shaft 32 for the left and right hand wheels of the associated motor vehicle.

The differential housing 18 may also include openings 20 which provide fluid communication between the differential housing 18 and the left and right torque vectoring systems 12 and 14. Accordingly, lubrication fluid may be shared between the non-driven differential 16 and the adjacent systems 12 and 14.

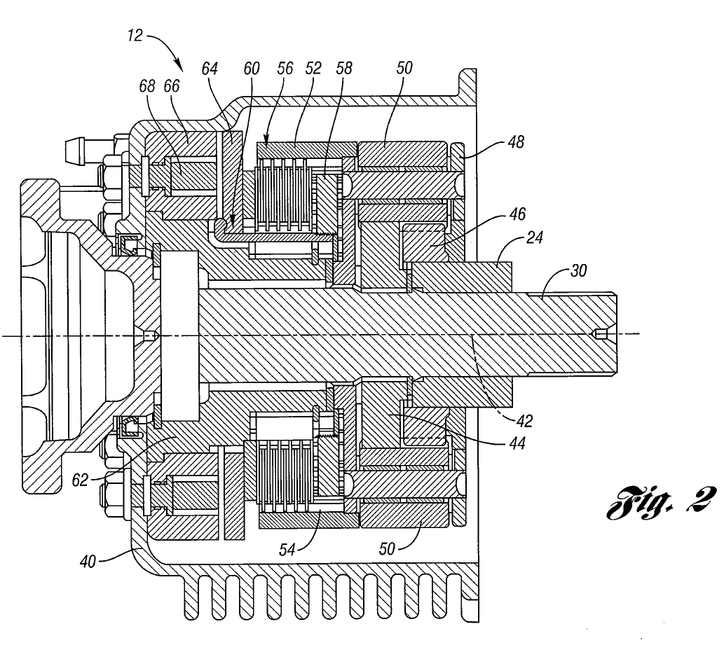

Now referring to FIGS. 1 and 2, the left torque vectoring system 12 includes a housing 40 coupled to the differential housing 18 such that the housing 40 is mechanically grounded relative to a vehicle chassis. A first sun gear 44 engages the shaft 30 through a splined or geared engagement. Accordingly, the first sun gear 44 rotates together with and at the same speed as the shaft 30. The first sun gear 44 engages a plurality, such as for example, four planet gears 50 that are carried on and housed in a carrier 48. The first sun gear 44 includes a plurality of teeth about the outer circumference of the first sun gear 44. In addition, a second sun gear 46 is provided. The second sun gear 46 engages the differential carrier 24 about an inner circumference and the plurality of planet gears 50 about an outer circumference. The first and second sun gears 44 and 46 have a gear ratio other than one with respect to each other. Specifically, the second sun gear 46 may have a different number of teeth than the first sun gear 44 and that this difference is preferably an integer multiple of the number of planet gears 50. For example, the first sun gear 44 may have more teeth than the second sun gear 46 to overdrive the shaft 30. Alternatively, the first sun gear 44 may have fewer teeth to underdrive the shaft 30. This can be implemented by varying the pitch, pitch diameters, and/or profile of the gears. For instance, if an optimum gear match included 38 teeth, the first sun gear 44 could include 40 teeth while the second sun gear 46 could include 36 teeth. Accordingly, a gear ratio of 1.11 would be created allowing the shaft 30 to be overdriven or underdriven by 10% at such time that the relative rotational speed of the carrier 48 is reduced to zero. At least one, but preferably each of the planetary gears 50 engage the first and second sun gears 44 and 46. The carrier 48 also includes a portion 52 extending from the carrier 48 and including teeth 54 about an inner circumference. The teeth 54 mesh with external teeth on clutch plates from the clutch pack 56.

In a first mode of operation, which may be a normal mode of operation where the vehicle is being driven straight and the left and right wheel speeds are equal, the clutch pack 56 is not compressed allowing a first set of clutch plates to rotate relative to a second set of clutch plates. The first set of clutch plates engage the teeth 54 and thus the carrier 48 rotates freely relative to the second set of clutch plates in the first mode. Accordingly, in the first mode, the shaft 30, the first sun gear 44, the second sun gear 46, and the carrier 48 all rotate about the shaft central axis 42 at the shaft speed. As such, the planet gears 50 do not rotate about their central axis, but rotate with the carrier 48 about the shaft central axis 42.

In a second mode of operation, for example an enhanced torque mode, the clutch pack 56 is compressed. To compress the clutch pack 56, the coil assembly 66 includes a coil 68 that forms an electromagnet. The coil assembly 66 is fastened to the housing 40 and mechanically grounded through the housing 40. For example, coil assembly 66 may be fastened to the housing 40 using bolts. In addition, a grounding ring 62 is also mechanically grounded to the housing 40 through the coil assembly 66. An armature 64 is located adjacent the coil assembly 66. The electromagnetic force generated by current running through the magnetic coil 68 pulls the armature 64 toward the coil 68. The armature 64 in turn pulls the armature assembly 60 toward the magnetic coil 68. In addition, the armature assembly 60 may engage a retaining plate 58, such as for example, through a threaded engagement. Accordingly, the motion of the armature assembly 60 pulls the retaining plate 58 towards the coil 68 thereby compressing the clutch pack 56.

As the retaining plate 58 compresses the clutch pack 56, the first set of clutch plates that engage the teeth 54, frictionally engage the second set of clutch plates. Accordingly, the first set of clutch plates transfer torque to the second set of clutch plates, which are engaged with the grounding ring 62. In this mode, the first sun gear 44 rotates at the same speed as the shaft 30. However, the gear ratio between the first and second sun gear 44 and 46 forces the differential carrier 24 to rotate faster (or slower depending on the gear ratios) relative to the shaft 30 and the corresponding vehicle tire. Meanwhile, the carrier 48 and planet gears 50 rotate at a variable speed that is determined based on the degree of frictional engagement of the clutch pack 56. Accordingly, torque from the carrier 48 may be amplified, for example by ten times, through the first and second sun gears 44 and 46, generating opposite torques between the shaft 30 and the differential carrier 24. In this mode, as the torque vectoring system 12 increases (or decreases) the speed of the differential carrier 24 relative to its corresponding shaft 30, the pinion right gear 27 rotates about its axis and transfers by engagement of its teeth the speed difference to the opposing side gear 33 which is engaged to the opposing shaft 32, thereby communicating a torque output from the non-driven differential 16 to the opposing shaft 32.

Additional details of the torque vectoring system 12 are provided with reference to FIGS. 3-14. The torque vectoring system 14 is a mirrored construction of torque vectoring system 12. In FIG. 3, the housing 40 is provided for the torque vectoring system 12. A seal 70 is pressed into an opening in the housing 40. The seal 70 will prevent the leakage of lubrication fluid between the shaft 30 and the housing 40. The housing 40 may be formed from aluminum to reduce weight. Although, it is understood that the housing 40 may be formed from steel or other rigid materials, it is preferable for the material to be non-ferrous so that it does not interfere with the optimal flow of magnetic flux from the coil assembly 66 through the armature 64. The grounding ring 62 is pressed into the coil assembly 66. The coil assembly 66 may be bolted to the housing 40 thereby mechanically grounding the coil assembly 66 and grounding ring 62 through the housing 40 and preventing the rotation thereof with respect to the differential housing 18 and a vehicle chassis. The coil assembly 66 also includes coil terminals 71 allowing electrical connection to the coil 68 for electromagnetic actuation of the clutch pack 56.

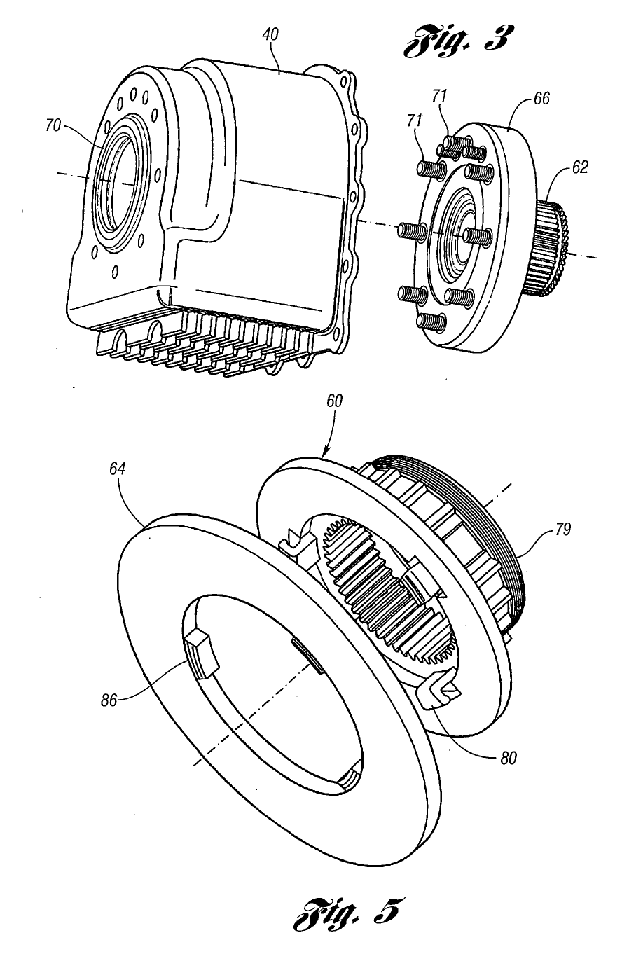

Referring now to FIG. 4, the armature assembly 60 includes the armature 64, a tube portion 72, a ring 74, and a plate 76. The armature 64 maybe formed from a ferrous material. The tube portion 72 may be constructed of aluminum, although other preferably non-ferrous rigid material may be used. A threaded segment 79 is located at a first end of the tube portion 72. A second segment of the tube portion 72 extends from the threaded segment 79 to a segmented flange 80 at the second end of the tube portion 72. The second segment may be formed from a plurality of legs 78, such as for example, three legs extending from the threaded segment 79 to the flange 80. The legs 78 may be spaced equally about the circumference of the tube portion 72, such as for example, at 120° increments. The legs 78 may be of equal size and length or alternatively may have different sizes or different lengths. Further, one of ordinary skill in the art would understand that other configurations of legs may be used including legs that have different lengths or that are not equally spaced about the circumference of tube portion 72.

The ring 74 may be made from a metal or other rigid material, for example steel. The ring 74 includes a first set of teeth around the internal circumference and a second set of teeth around the external circumference of the ring 74. In addition, the ring 74 may include slots 82 configured to slidingly receive the legs 78 from the tube portion 72. Accordingly, the legs 78 of the tube portion 72 are received in the recesses 84 over the ring portion 74. The plate 76 is located adjacent to the ring 74 and slidingly engaged to the legs 78 of the tube portion 72 extend through recesses 84 in the inner circumference of the plate 76. The plate 76 may be made from a metal or other preferably non-ferrous rigid material, such as for example, stainless steel.

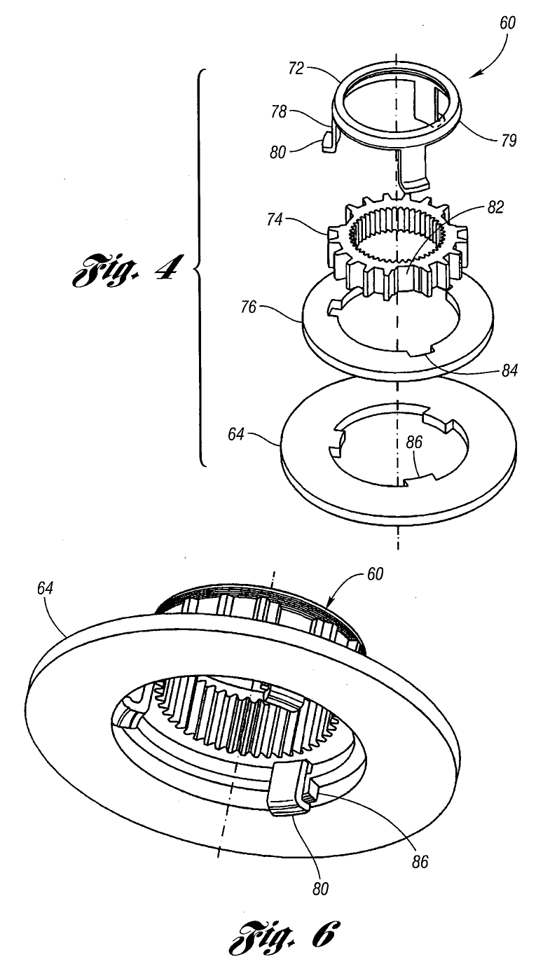

As shown in FIG. 5, the tube portion 72, the ring portion 74, and the plate 76 assemble together to form the armature assembly 60 with the threaded segment 79 extending from a first end of the armature assembly 60 and the flanges 80 on the tip of the legs 78 extending from the opposite end of the armature assembly 60. The legs 78 extend from the threaded segment 79 through recesses in the ring 74 and the plate 76 to rotationally but slidingly align the tube portion 72. The plate 76 is positioned in the assembly against a surface on the grounding ring 62. In addition, the legs 78 may extend through the inner circumference of the armature 64. The armature 64 may include tabs 86, such that the flanges 80 may engage the tabs 86 by rotating the armature 64 with respect to the tabs 86 as shown in FIG. 6. Accordingly, the armature 64 becomes affixed to the armature assembly 60 such that movement of the armature 64 by the electromagnetic force from the coil 68 will also cause motion of the tube portion 72 of the armature assembly.

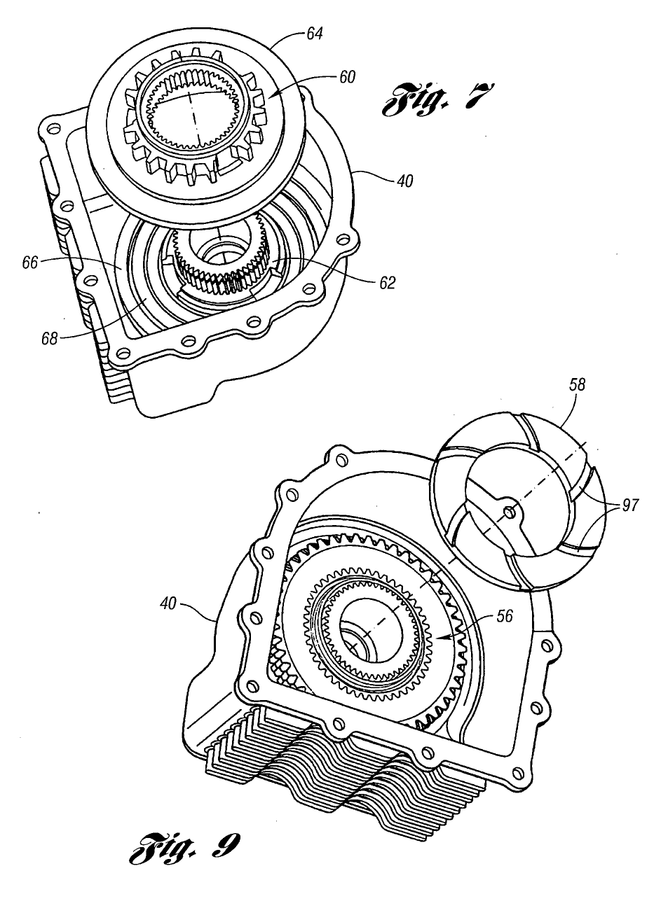

Now referring to FIG. 7, the armature assembly 60 along with the armature 64 are inserted over the grounding ring 62, such that the teeth around the inner circumference of the armature assembly 60 rotationally engage the teeth about the outer circumference of the grounding ring 62. However, the teeth on the inner surface of the armature 60 and the teeth on the outer surface of the grounding ring 62 allow a linear motion of the armature assembly 60 along the central axis 42 of the shaft 30 while preventing rotational motion about the central axis 42. This allows the armature assembly 60 to move toward but not contact the coil assembly 66 when the coil 68 is activated causing the clutch pack 56 to compress.

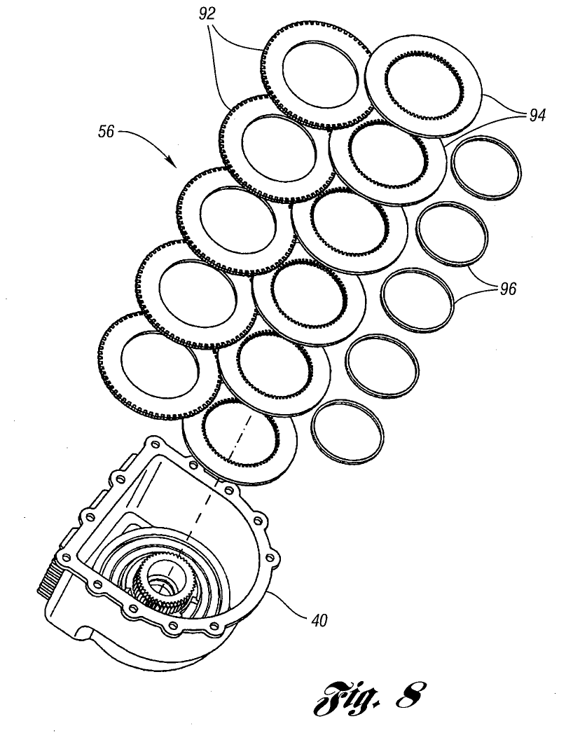

Now referring to FIG. 8, assembly of the clutch pack 56 is illustrated. The clutch pack 56 includes a first set of clutch plates 92, a second set of clutch plates 94, and a set of wave springs 96. The first set of clutch plates 92 include teeth about the external circumference of each clutch plate to engage the carrier 48. The wave springs 96 and the second set of clutch plates 94 have an outer diameter small enough to rotate freely with respect to the carrier 48. The second set of clutch plates 94 include teeth about an internal circumference of each clutch plate. As such, the teeth around the outer circumference of the armature assembly 60 engage the teeth in the inner circumference of the second set of clutch plates 94. However, the first set of clutch plates 92 and the wave springs 96 have a large enough inner diameter such that they are not engaged by the outer teeth of the armature 60. The first set of clutch plates 92, the wave springs 96, and the second set of clutch plates 94 are sequentially located over the ring portion 74. In one example, a clutch plate from the first set of clutch plates 92 is placed over the ring portion 74, then a wave spring 96, then a clutch plate from the second set of clutch plates 94, and then the sequence is repeated. However, one of ordinary skill in the art could readily understand that other sequences may be readily used, for example a wave spring between each clutch plate. The wave springs 96 are provided to reduce clutch drag and act as a return spring between the first and second set of clutch plates 92 and 94.

Now referring to FIG. 9, insertion of the retaining plate 58 is illustrated. The retaining plate 58 is threaded about its inner circumference and is configured to threadedly engage the threaded segment 79 of the tube portion 72. Accordingly, the retaining plate 58 is screwed onto the threaded segment 79 of the tube portion 72. In addition, the threads of the retaining plate 58 and the threads of the tube portion 72 are configured for example such that one rotation of the retaining plate 58 causes a one millimeter displacement of the retaining plate 58 along the central axis 42 of the shaft 30. Accordingly, the retaining plate 58 may be tightened to fully compress the clutch plates 92 and 94 and wave springs 96 of the clutch plate pack 56 and then backed off to provide a desired clutch pack clearance. For example, the retaining plate 58 may be backed off 1.5 turns for a 1.5 millimeter clutch pack clearance. Then the threads may be staked to prevent the retaining plate 58 from backing off of the tube portion 72 of the armature assembly 60. This allows for easy assembly of the torque vectoring system 12 and adjustment of the clutch pack clearance. The retaining plate 58 may also include grooves for example, spirally formed channels 97 in the surface of the retaining plate 58. The channels 97 may be formed on the face of the retaining plate 58 located opposite the clutch pack 56. Accordingly, a moving component located adjacent channels 97 of the retaining plate 58, for example the carrier 48, will cause a flow of lubricating fluid to the inside of the clutch pack 56 due to rotation of the adjacent part. Accordingly, the spirally formed channels 97 may expand in diameter rotationally in a direction opposite the direction of the rotation of the adjacent component. The retaining plate 58 may be formed from aluminum although other metals or rigid materials may be used.

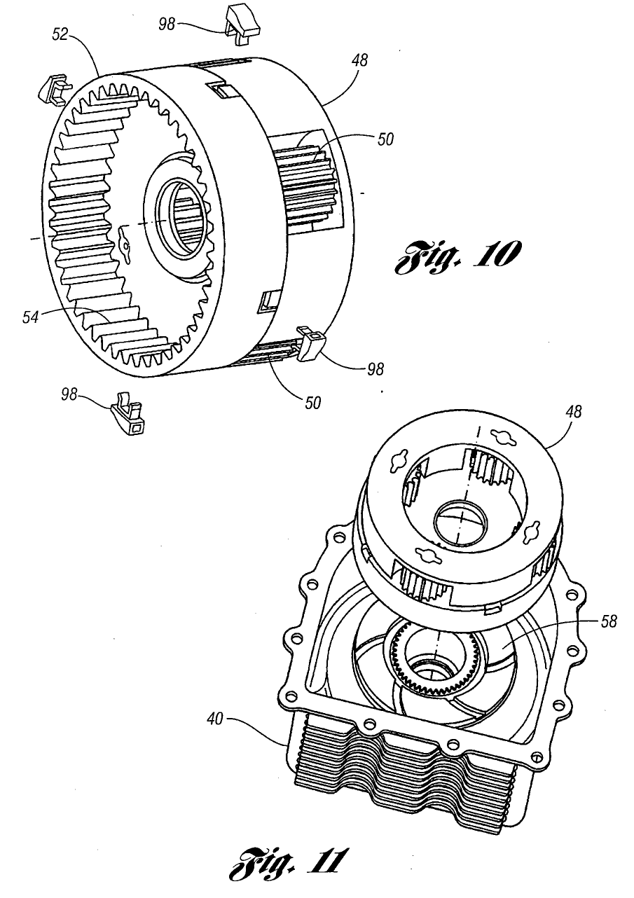

Now referring to FIG. 10, a perspective view of the carrier 48 is provided. The carrier 48 may be located adjacent to the retaining plate 58, as described above. The carrier 48 may include a portion 52 extending from the carrier. The portion 52 may include teeth 54 about an internal circumference of the extended portion 52. The carrier 48 may also include a set of planet gears 50 equally spaced about the carrier 48. For example, the carrier 48 may include four planet gears 50 positioned every 90° about the circumference of the carrier 48. The planet gears 50 may be pinned into a wall of the carrier 50 and configured to rotate about the pin with teeth of the planet gears 50 extending beyond the wall of the carrier 48 to engage other components. The carrier 48 may include scoops 98 having an opening facing the direction of rotation of the carrier 48. The scoops 98 direct lubricating fluid from the opening of the scoop 98, through an opening in the carrier 48, and into the center of the carrier 48. The scoops 98 may be located about the circumference of the carrier 48. For example, four scoops may be located every 90° about the circumference of the carrier 48. The scoops 98 may be formed from nylon and may clip into openings in the carrier 48. Although, one of ordinary skill in the art would understand that other scoop configurations including scoop spacing or material may be utilized within the scope of the present invention.

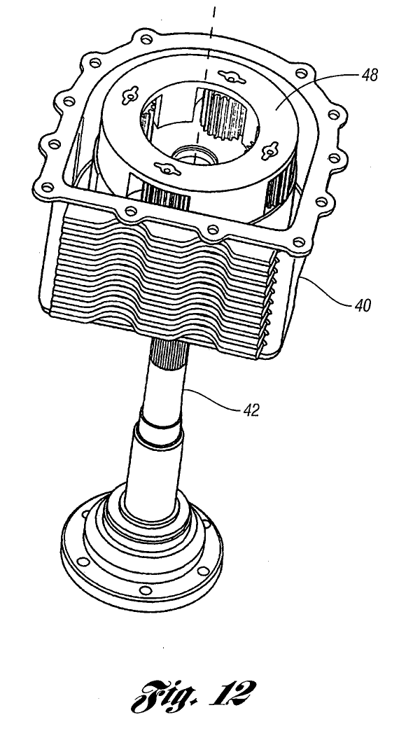

Now referring to FIG. 11, the carrier 48 may be located over the retaining plate 58 and clutch pack 56. The teeth 54 are configured to engage the teeth on the first set of clutch plates 92. Accordingly, the teeth on the first set of clutch plates 92 will need to be aligned prior to sliding the carrier 48 over the clutch pack 56. As such, the teeth 54 engage the first set of clutch plates 92 of the clutch pack 56 and are configured to rotate in conjunction therewith about the shaft central axis 42.

Now referring to FIG. 12, the shaft 30 is inserted through the housing 40, as well as, the other components of the torque vectoring system 12. The shaft 30 may be formed from steel and may be induction heat treated due to the amount of torque transferred therethrough. As such, the shaft 30 seats against the seal 70 in the housing 40 to prevent the leakage of lubrication fluid from the torque vectoring system 12.

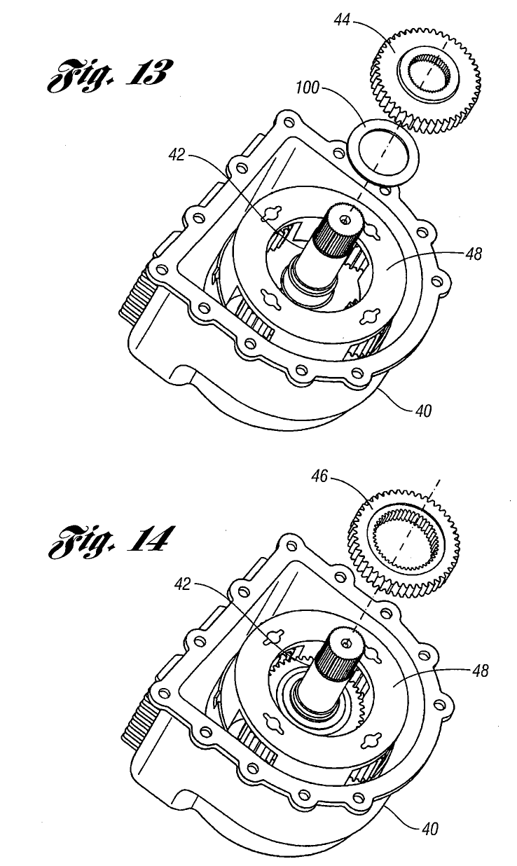

Now referring to FIG. 13, a thrust washer 100 may be inserted over the shaft 30 and against the carrier 48. Then a first sun gear 44 may be inserted over the shaft 30. The first sun gear 44 may include teeth along an inner circumference that is configured to engage teeth in the shaft 30 causing the first sun gear 44 to rotate in conjunction with the shaft 30 about the shaft central axis 42. In addition, the sun gear 44 includes a plurality of teeth located about the outer circumference of the sun gear 44 that are configured to engage the planet gears 50 located in the carrier 48. The first sun gear 44 may be formed from steel, however, other rigid materials may also be used.

Now referring to FIG. 14, a second sun gear 46 may be located over the shaft 30. The second sun gear 46 may be formed from steel, however, other rigid materials may be used. The second sun gear 46 includes a plurality of teeth around the outer circumference of the second sun gear 46 that also engage the planet gears 50 of the carrier 48. However, the number of teeth, size of the teeth, or pitch of the teeth are different from the first sun gear 44. Accordingly, a gear ratio is generated between the first and second sun gears 44 and 46 while both gears are engaged with the planet gears 50 located about the carrier 48. Further, in the embodiments shown, the first sun gear 44 and the second sun gear 46 are both engaged with all four of the planet gears 50 contained within the carrier 48. Although one of ordinary skill in the art would recognize that a greater or fewer number of planet gears 50 may be incorporated into the carrier 48 and utilized in conjunction with the first and second sun gears 44 and 46. Further, it is also readily apparent that different gear ratios may be developed between the first and second sun gears 44 and 46. However, in the example described, a gear ratio of 1.11 may be readily used to increase the torque provided to the wheel through the shaft 30.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A torque vectoring axle assembly for a non-driven axle of a motor vehicle, the assembly comprising:
a non-driven differential (16) including a differential carrier (24); and
a first torque vectoring system (12) including:
a first shaft (30) configured to receive a first torque output from the non-driven differential (16) and to rotate about a shaft central axis (42);
a first gear (44) in communication with the first shaft (30) and configured to rotate in conjunction therewith about the shaft central axis (42);
a second gear (46) in communication with the differential carrier (24) and configured to rotate about the shaft central axis (42); and
a first set of planet gears (50) in communication with the first and second gears (44, 46) and wherein the first and second gears (44, 46) have a first gear ratio other than one.

2. The assembly according to claim 1 further comprising a second torque vectoring system including:
a second shaft (32) configured to receive a second torque output from the non-driven differential (16) and to rotate about the shaft central axis (42);
a third gear in communication with the second shaft (32) and configured to rotate in conjunction therewith about the shaft central axis (42);
a fourth gear in communication with the differential carrier (24) and configured to rotate about the shaft central axis (42); and
a second set of planet gears in communication with the third and fourth gears and wherein the third and fourth gears have a second gear ratio other than one.

3. The assembly according to claim 2 wherein one of the second gear (46) and the fourth gear respectively communicates one of the second torque output and the first torque output to the non-driven differential (16) during an enhanced torque mode of operation.

4. The assembly according to claim 2 wherein the non-driven differential (16) further includes a first side gear (28) in communication with the first shaft (30) and configured to rotate in conjunction therewith about the shaft central axis (42), a second side gear (33) in communication with the second shaft (32) and configured to rotate in conjunction therewith about the shaft central axis (42), a first pinion (26) in communication with the differential carrier (24) and the second side gear (33) and configured to rotate in conjunction with the second side gear (33) about a first pinion axis to communicate the second torque output from the non-driven differential (16) to the second shaft (32), and a second pinion (27) in communication with the differential carrier (24) and the first side gear (28) and configured to rotate in conjunction with the first side gear (28) about a second pinion axis to communicate the first torque output from the non-driven differential (16) to the first shaft (30).

5. The assembly according to claim 2 wherein the non-driven differential (16) and the first and second torque vectoring systems (12, 14) are in fluid communication such that lubrication fluid is shared between the non-driven differential (16) and the first and second torque vectoring systems (12, 14).

6. The assembly according to claim 1 wherein the non-driven differential (16) does not include a ring gear, whereby the non-driven differential (16) does not receive input torque from an engine of the motor vehicle.

7. The assembly according to claim 1 wherein the non-driven differential (16) is one of an open differential, a planetary gear set differential and an all spur gear differential.

8. The assembly according to claim 1 wherein at least one planet gear of the first set of planet gears (50) engages both the first and second gears (44, 46).

9. The assembly according to claim 1 wherein the first and second gears (44, 46) are sun gears.

10. The assembly according to claim 1 wherein the first gear (44) has a different number of teeth than the second gear (46).

11. The assembly according to claim 1 wherein the first torque vectoring system (12) further includes a carrier (48) that is configured to rotate about the shaft central axis (42) and the first set of planet gears (50) are housed about a circumference of the carrier (48).

12. The assembly according to claim 11 wherein the first torque vectoring system (12) further includes a clutch pack (56) and the carrier (48) includes a plurality of teeth configured to engage the clutch pack (56).

13. The assembly according to claim 12 wherein the first gear (44), the second gear (46), and the carrier (48) are configured to rotate at a shaft speed of the first shaft (30) when the clutch pack (56) is disengaged.

14. The assembly according to claim 13 wherein the first gear (44) rotates at the shaft speed of the first shaft (30) and the second gear (46) rotates at a different speed than the first gear (44) when the clutch pack (56) is engaged.

15. A torque vectoring axle assembly for a non-driven axle of a motor vehicle, the assembly comprising:
a non-driven differential (16) including a differential carrier (24); and
a first torque vectoring system (12) including:
a first shaft (30) configured to receive a first torque output from the non-driven differential (16) and to rotate about a shaft central axis (42);
a first gear (44) in communication with the first shaft (30) and configured to rotate in conjunction therewith about the shaft central axis (42);
a second gear (46) in communication with the differential carrier (24) and configured to rotate about the shaft central axis (42), wherein the first gear (44) has a different number of teeth than the second gear (46);
a first set of planet gears (50) in communication with the first and second gears (44, 46), wherein at least one planet gear of the first set of planet gears (50) engage both the first and second gears (44, 46);
a first carrier (48) configured to house the first set of planet gears (50) about a circumference of the first carrier (48) and the first carrier (48) being configured to rotate about the shaft central axis (42);
a first coil assembly (66) including a first coil (68) to generate a first electromagnetic force;
a first armature assembly (60) located adjacent the first coil assembly (66) such that the first electromagnetic force pulls the first armature assembly (60) toward the first coil assembly (66) when activated, the first armature assembly (60) being configured to move axially along the shaft central axis (42);
a first clutch pack (56) in communication with the first carrier (48); and
a first retaining plate (58) attached to the first armature assembly (60) and configured to compress the first clutch pack (56).

16. The assembly according to claim 15 further comprising a second torque vectoring system (14) including:
a second shaft (32) configured to receive a second torque output from the non-driven differential (16) and to rotate about a shaft central axis (42);
a third gear in communication with the second shaft (32) and configured to rotate in conjunction therewith about the shaft central axis (42);
a fourth gear in communication with the differential carrier (24) and configured to rotate about the shaft central axis (42), wherein the third gear has a different number of teeth than the fourth gear;
a second set of planet gears in communication with the third and fourth gears, wherein at least one planet gear of the second set of planet gears engage both the third and fourth gears;
a second carrier configured to house the second set of planet gears about a circumference of the second carrier and the second carrier being configured to rotate about the shaft central axis (42);
a second coil assembly including a second coil to generate a second electromagnetic force;
a second armature assembly located adjacent the second coil assembly such that the second electromagnetic force pulls the second armature assembly toward the second coil assembly when activated, the second armature assembly being configured to move axially along the shaft central axis (42);
a second clutch pack in communication with the second carrier; and
a second retaining plate attached to the second armature assembly and configured to compress the second clutch pack.

17. The assembly according to claim 16 wherein the non-driven differential (16) further includes a first side gear (28) in communication with the first shaft (30) and configured to rotate in conjunction therewith about the shaft central axis (42), a second side gear (33) in communication with the second shaft (32) and configured to rotate in conjunction therewith about the shaft central axis (42), a first pinion (26) in communication with the differential carrier (24) and the second side gear (33) and configured to rotate in conjunction with the second side gear (33) about a first pinion axis to communicate the second torque output from the non-driven differential (16) to the second shaft (32), and a second pinion (27) in communication with the differential carrier (24) and the first side gear (28) and configured to rotate in conjunction with the first side gear (28) about a second pinion axis to communicate the first torque output from the non-driven differential (16) to the first shaft (30).

18. The assembly according to claim 15 wherein the non-driven differential (16) does not include a ring gear, whereby the non-driven differential (16) does not receive input torque from an engine of the motor vehicle.

19. The assembly according to claim 15 wherein the first retaining plate (58) is threaded onto an end of the first armature assembly (60).

20. The assembly according to claim 15 wherein the first retaining plate (58) is located adjacent to the first carrier (48) and includes spirally formed channels (97) configured to direct lubrication fluid into a middle of the first clutch pack (56).

21. The assembly according to claim 20 wherein the first clutch pack (56) is configured to transfer torque between the first carrier (48) and a mechanical ground (62).

22. The assembly according to claim 15 wherein the first gear (44), the second gear (46), and the first carrier (48) are configured to rotate at a shaft speed of the shaft when the first clutch pack (56) is disengaged and wherein the first gear (44) rotates at the shaft speed of the first shaft (30) and the second gear (46) rotates at a different speed than the first gear (44) when the clutch pack is engaged.

23. The assembly according to claim 15 wherein the first armature assembly (60) comprises:
a tube portion (72) including a threaded segment (79) on a first end and legs (78) extending from the threaded segment with a flange on a second end opposite the first end;
a ring portion (74) having teeth configured to engage the first clutch pack (56) and recesses (82) configured to slidably receive the legs (78) of the tube portion (72).

24. The assembly according to claim 23 wherein the first armature assembly (60) further comprising a plate (76) including recesses (84) along a circumference of an inner opening configured to allow the legs (78) of the tube portion (72) to extend therethrough.

25. The assembly according to claim 23 wherein an armature (64) of the first armature assembly (60) includes tabs (86) and the flanges (80) of the tube portion (72) are configured to engage the tabs (86).
